(19) United States
(12) Patent Application Publication
(10) Pub. No.: US 2001/0038631 A1
(43) Pub. Date: Nov. 8, 2001

(54) Method for clarifying and compressing ATM connection type information

(76) Inventors: Jeong Yun Kim, Taejon (KR); Sung Back Hong, Taejon (KR)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 09/770,721

(22) Filed: Jan. 25, 2001

(30) Foreign Application Priority Data
Jan. 28, 2000 (KR) 2000-4131

(51) Int. Cl. H04L 12/28

(52) U.S. Cl. 370/395; 370/389

(57) ABSTRACT

In the ATM switching system using an asynchronous transfer mode (ATM) signaling protocol, a method for analyzing a SETUP message which is requesting a setup for a ATM connection and a MODIFY REQUEST message which is requesting a modification of a traffic property of the ATM connection to clarify the ATM connection type information to be setup and a method for compress the clarified ATM connection type information are provided according to the present invention. Disadvantages of a conventional ATM connection are that connection type information of an ATM connection are different one another, and also a large quantity of memory is required to construct connection type information since complicated and various ATM connection type information are independently constructed for each of signaling protocols. Therefore, an construction method which can clarify the ATM connection type information which is applicable to all types of the ATM signaling protocols and can efficiently use the memory is needed. The method according to the present invention for clarifying ATM connection type information are to be unified so that the method is applicable to all types of the ATM signaling protocols. And ATM connection type information is to be compressed using a POWERSET mode into one information identifier. Therefore information management is unified in whole ATM network so that management efficiency of operational manager can be enhanced and the signaling protocols and connection information that are used for a setup of ATM connection can be easily identified.

### TECHNICAL FIELD

The present invention relates to an asynchronous transfer mode (ATM) system, and more specifically, to a method for clarifying an ATM connection type information to analyze a SETUP message which is requesting a setup for an ATM connection in the ATM device using an ATM signaling protocol and a method for compressing a clarified ATM connection type information.

### BACKGROUND OF THE INVENTION

In an ATM device, ATM signaling could perform the functions for setting up an ATM connection and releasing the ATM connection. Specially, a connection that is setup in this manner is referred to as a switched virtual connection. In the ATM connection that is established in this manner, various ATM connection types are determined by the demands of a calling side user that starts a connection request. Recently, ATM signaling protocols that can be used in an ATM network are typically classified into ITU-T recommendations and the ATM Forum specifications. The recommendations specified in ITU-T recommendation include DSS2 (B-ISDN Digital Service Signaling System NO.2) recommendation at UNI (User Network Interface and B-ISUP (B-ISDN User Part) recommendation at Public NNI (Network Node interface). Otherwise, ATM Forum defined UNI 3.1 and UNI 4.0 specification at UNI, B-ICI (Broadband Inter Carrier Interface) specification at Public NNI, and P-NNI (Private NNI) specification at Private NNI.

FIG. 1 illustrates a general ATM network configuration. As shown in FIG. 1, several ATM signaling protocols need to establish an end-to-end ATM connection. In addition, the more ATM network configuration is complicated, the more ATM signalling protocols are involved in establishing an ATM connection. ATM switching systems, accommodating up to several ATM: signaling protocols together, create and handle the structures of ATM connection types according to each protocol. So, to manage different structures of ATM connection types to an ATM connection, the inefficient problem would be occurred. The present invention is intended to devise the method for clarifying ATM connection type information and for constructing the information structure, applicable to all kinds of ATM signalling protocols. First, the ATM connection types are classified according to ATM signaling protocols such as DSS2, UNI 3.1, UNI 4.0, B-ISUP, B-ICI, and P-NNI involved in establishing an ATM connection. And the ATM connection types are classified according to connection configurations such as a point-to-point (PtP) ATM connection and a point-to-multipoint (PtMP) ATM connection. The ATM connection types are sorted according to ATM transfer capability (ATC) such as Deterministic Bit Rate (DBR), Statistical Bit Rate (SBR), Available Bit Rate (ABR), Unspecified Bit Rate (UBR).

And also, the ATM connection types can be classified according to ATM traffic negotiation capability and ATM traffic modification capability of the ATM connection. The ATM connection types can be classified according to service type to be provided such as Native ATM service, or ATM Interworking service including NISDN service and Internet service. In accordance with level of ATM layers, the ATM connection types can be classified into an ATM virtual channel (VC) connection and an ATM virtual path (VP) connection. The ATM connection types can be classified into an ATM switched virtual connection (SVC) which is established purely by the only ATM signaling protocol, an ATM permanent virtual connection (PVC) which is established by a system manager, and a Soft-PVC ATM connection which is a combination of the ATM switched virtual connections in accordance with methods for setting up the ATM connection.

Meanwhile, owners of the ATM connection to be intended to be setup are classified into a calling side which sends a SETUP message which is requesting a connection setup and a called side which receives the sent the SETUP message.

In accordance with addressing, the ATM connection type can be divided into an en bloc type which transmits all of addresses of the called sides to the SETUP message, and an overlap type which transmits a part of addresses of the called sides to the SETUP message.

The above-mentioned information of the ATM connection types can be applied to both the ATM terminal and the ATM switching system which make use of ATM signaling protocols. But, Soft-PVC is only applicable to the B-ISUP, B-ICI, and P-NNI signaling protocols. Here, the DSS2 signaling protocol includes ITU-T recommendations of Q.2931, Q.2971, Q.2961, Q.2941, Q.2963, Q.2962, and the like. The B-ISUP signaling protocol includes ITU-T recommendations of Q.2761, Q.2762, Q.2763, Q.2764, Q.2722, Q.2723, Q.2726, Q.2766, Q.2767, and the like. The ATM signaling protocols specified in the ATM Forum includes the UNI 3.1 and UNI 4.0 protocol, B-ICI 2.1 protocol, and P-NNI 2.0 protocol. The SETUP message can be used in the UNI and the Private NNI for the purpose of the ATM connection setup. And an IAM (Initial Address Message) message can be used in the Public NNI for the purpose of the ATM connection setup. The SETUP message is corresponding to the IAM message. In the present invention, the IAM message and the SETUP message are used to be identical for the convenience.

As described above, the types of ATM connection are various and the connection type information is indicated in an information element in SETUP message. Therefore, a call control module receiving the SETUP message analyzes the SETUP message to determine the types of ATM connection for the requesting setup. The signaling protocol type of the ATM connection can be identified with protocol discriminator in received SETUP message and prescribed interface definition.

And the configuration type of ATM connection can be identified with the connection configuration field of Broadband Bearer Capability (B-BC) in SETUP message. The ATC type of ATM connection can be identified with the ATC field of B-BC in the SETUP message. The level type of ATM connection can be identified with the Bearer Class field of B-BC in SETUP message.

The ATM traffic negotiation capability is a connection type in the case that Minimum Acceptable ATM Traffic Descriptor information element exists in the SETUP message. And the ATM traffic modification capability is a connection type that is determined in the case that a MODIFY REQUEST message is received.

The service type of ATM connection is NISDN service when Narrow-band Bearer Capability (N-BC) information element exists in the SETUP message.

The service type of ATM connection is Internet service when Identifier related standard/application field of Generic Identifier Transport (GIT) information element exist in SETUP message.

If both above the information elements do not exist, the service type of ATM connection is to be native ATM service.

When a call control module in an ATM device sends SETUP message to peer call control module in another ATM device, the owner type of ATM connection is to be calling side. The owner type of ATM connection is to be called side when a call control module sends SETUP message to peer module.

When a Broadband Sending Complete information element exists in the SETUP message, the addressing type of ATM connection is to be en bloc. And when the Broadband Sending Complete information element does not exist in the SETUP message, the addressing type is overlap. Finally, Soft-PVC capability is a connection type when soft permanent virtual connection (PVC) called endpoint information element exists in the SETUP message.

As above described, the ATM connection is characterized in that it has very complicated and various types in comparison to a conventional Public Switched Telephone Network (PSTN) or a conventional Narrow-band Integrated Service Digital Network (NISDN).

Therefore, the ATM call control modules which are disposed to the ATM terminal or the ATM switching system must analyze the SETUP message to determine an ATM connection type to be setup and thereby to generate and manage the connection information. And, an ATM call control module must identify and manage 10 ATM connection types in similarity to the above mentioned classification methods.

For the 10 ATM connection types, the ATM call control module makes use of a SET mode and a BOOLEAN mode to manage the ATM connection type to be setup. And each of the SET mode and the BOOLEAN mode makes use of 1 byte memory.

In other word, while the ATM connection is to be setup and to be released, for one of the ATM connections, the ATM call control module must generate and manage 10 ATM connection types information, wherein 10 byes memory is used.

An ATM call control module which performs functions of the setup for the ATM connection is located at the ATM terminal and the ATM switching system, and holds a large scale of the ATM connection information in order to setup a plurality of the ATM connection at the same time. Furthermore, in the case of the ATM switching system, since more than millions of the ATM connections can be setup, information structure associated with the ATM connection type is to be more complicated so that large quantity of information is to be used and capacity of memory is required to be very large.

In addition, the ATM connection type information is to be used in operation and management module such as a statistical process function, an automatic transaction process function, and the like so that the quantity of the ATM connection type information is required to be compressed.

### SUMMARY OF THE INVENTION

In order to solve the above mentioned problems in the conventional techniques in the art, an object of the present invention is to provide a method for analyzing a complicated and various ATM connection types to clarify the ATM connection types which can be combined and to compress the ATM connection types, thereby reducing usage of memory and compressing information quantity of the ATM connection type information used in the ATM call control module and an operational management module

In order to achieve the object of the present invention, 10 ATM connection type information are to be compressed into one information to simplify implementations of the ATM connection setup and the operational management function and to unify information of the ATM connection types independently constructed in accordance with each of the ATM signaling protocols so that management efficiency for the ATM connection type can be enhanced in the ATM network

The foregoing and other objects, aspects and advantages will be better understood from the following detailed description of a preferred embodiment of the present invention with reference to the drawings.

### BRIEF DESCRIPTION OF THE DRAWINGS

FIG. 1 is a diagram of a general ATM network configuration.

FIG. 2 illustrates a procedure of a setup for an ATM connection passing through a Public NNI.

FIG. 3 illustrates a procedure of a setup for an ATM connection passing through a Private NNI.

FIG. 4A and 4B illustrate a method for clarifying and compressing ATM connection type information in accordance with the present invention.

### DETAILED DESCRIPTION OF THE INVENTION

The preferred embodiment of the present invention is described referring to the drawings.

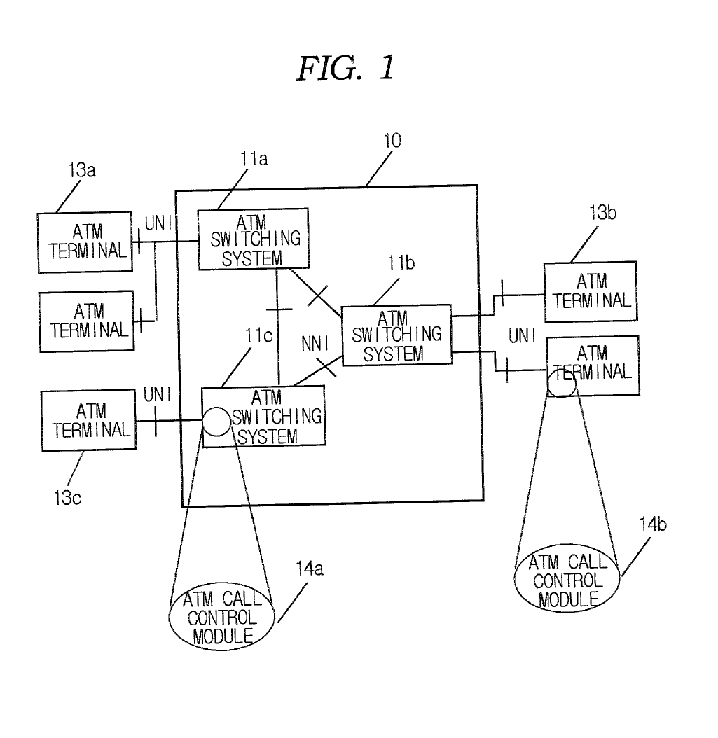

In an ATM network configuration shown in FIG. 1, UNI signalling protocol provided between an ATM terminal and an ATM switching system at UNI are ITU-T DSS2 signaling protocol or the ATM Forum LINI3.1 and UNI4.0 signaling protocol. In the case of using the ITU-T B-ISUP signaling protocol or the ATM Forum B-ICI signaling protocol, the Public NNI interface is provided between the ATM switching systems. And, in the case of using the ATM Forum P-NNI signaling protocol, the Private NNI interface is provided between the ATM switching systems.

ATM call control module for performing function for setting up the ATM connection exists in both an ATM terminal and an ATM switching system. And in each of the ATM call control modules, a suitable signaling protocol exits in accordance with its the ATM network configuration.

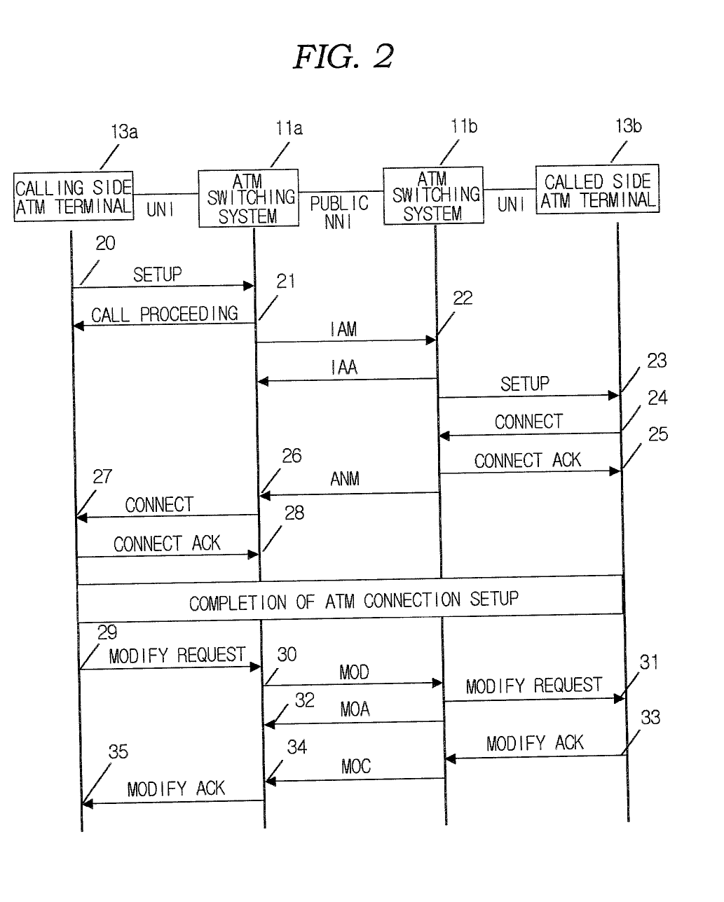

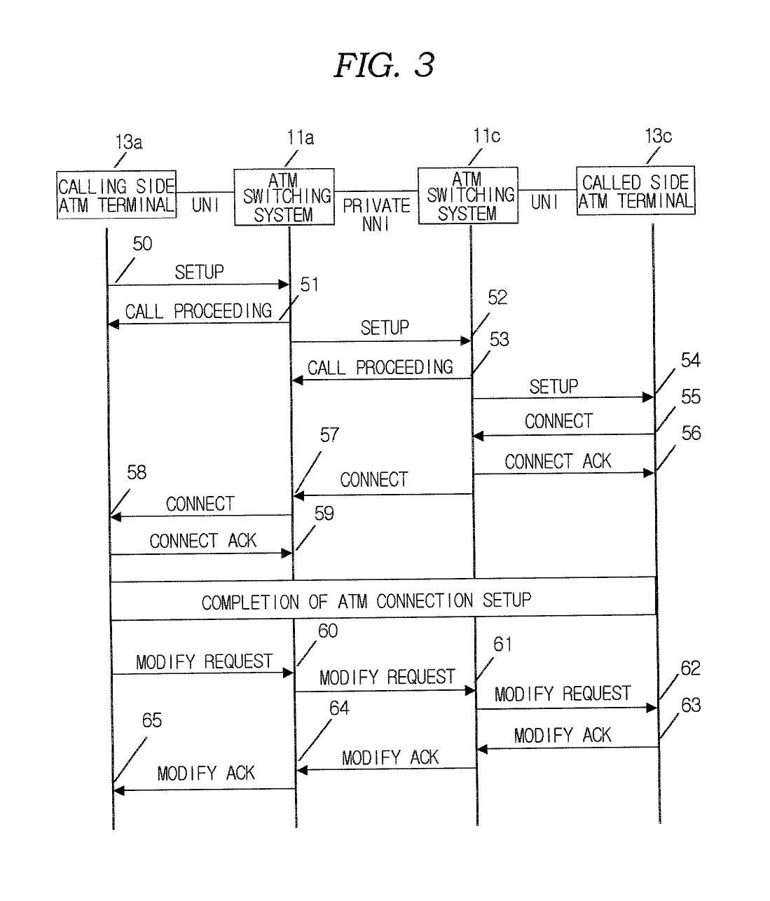

The ATM connection can be setup through the procedure shown in FIG. 2 in the case of passing through the Public NNI interface. And the ATM connection can be setup through the procedure shown in FIG. 3 in case of passing through the Private NNI interface.

In the Public NNI interface, ITU-T B-ISUP protocol or ATM Forum B-ICI protocol can be used. And in Private NNI interface, the ATM Forum P-NNI signaling protocol can be used.

A message for starting the ATM call setup is a SETUP message 20. A message for issuing the ATM call setup completion is a CONNECT ACK message 28. After the ATM connection setup is completed, a MODIFY REQUEST message 29 is to request modification of the ATM traffic, and a MODIFY ACK message 35 is issuing the completion of the traffic modification.

Now, the procedure of the setup for the ATM connection is described in details.

Referring to FIG. 2, a calling side ATM terminal 13a determines the ATM connection type to request, and then transmits the SETUP message 20. On receipt of the SETUP message 20, the ATM switching system 11a transmits a CALL PROCEEDING message 21 to the calling side ATM terminal 13a, and then analyzes the received SETUP message 20 to clarify the ATM connection type which user requests. After that, the ATM switching system 11a transmits an IAM message 22 to an ATM switching system 11b. On receipt of the IAM message 22, the ATM switching system 11b transmits an IAA (Initial Address Message Acknowledgement) to the ATM switching system 11a. After clarifying the ATM connection type in similarity to the ATM switching system 11a, the ATM switching system 11b transmits the SETUP message 23 to the called side ATM terminal 13b.

When the requested setup for the ATM connection is completed, the called side ATM terminal 13b transfers a CONNECT message 24 to the ATM switching system 11b. And the called side ATM terminal 13b receives a CONNECT ACK message 25 from the ATM switching system 11b. The ATM switching system 11b transfers an ANM (Answer Message) message 26 to the ATM switching system 11a. And the ATM switching system 11a transmits a CONNECT message 27 the called side ATM terminal 13a. And, at the time that a CONNECT ACK message 28 is received from the called side ATM terminal 13a, the ATM connection setup is completed.

After the ATM connection setup is completed, if the ATM switching system 11a receives a MODIFY REQUEST message 29 from the calling side ATM terminal 13a, the ATM switching system 11a transmits a MOD (MODIFY REQUEST) message 30 to the ATM switching system 11b. And the ATM switching system 11b transmits a MODIFY REQUEST message 31 to called side ATM terminal 13b and a MOA (MODIFY ACK) message 32 to the calling side ATM terminal 13a. The called side ATM terminal 13b transfers a MODIFY ACK message 33 to the ATM switching system 11b in response to the traffic modification request. And the ATM switching system 11b transmits a MOC (MODIFY CONFIRM) message 34 to the ATM switching system 11a. The ATM switching system 11a transmits a MODIFY ACK message 35 to the called side ATM terminal 13a, and then a traffic modification is completed.

FIG. 3 illustrates a procedure of a setup for an ATM connection passing through the Private NNI interface and is the same as the procedure of a setup for an ATM connection passing through the Public NNI interface shown in FIG. 2.

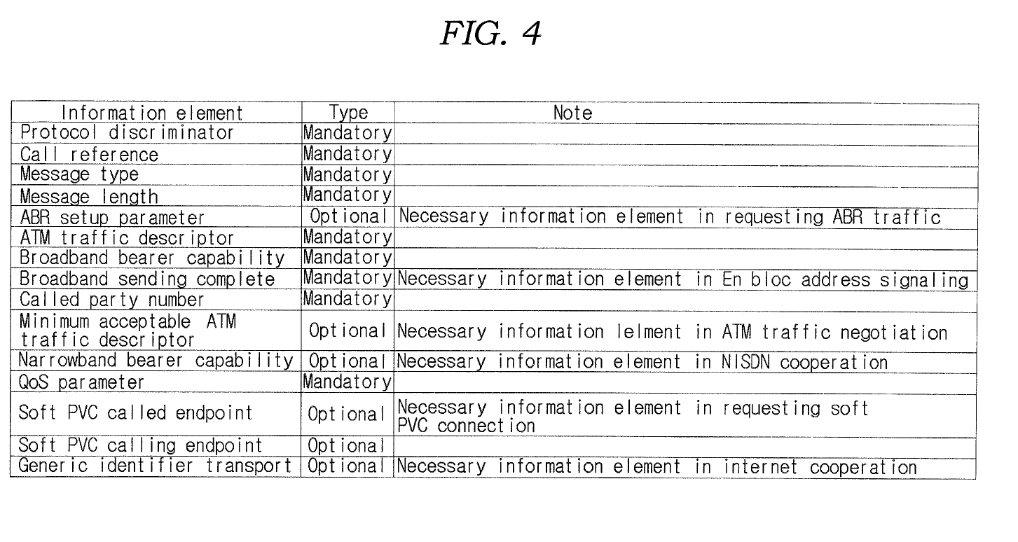

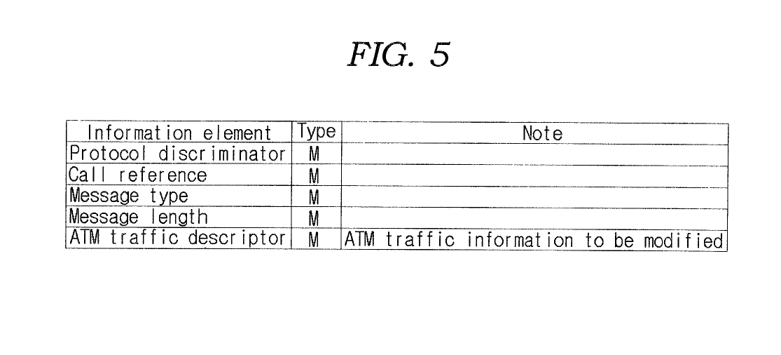

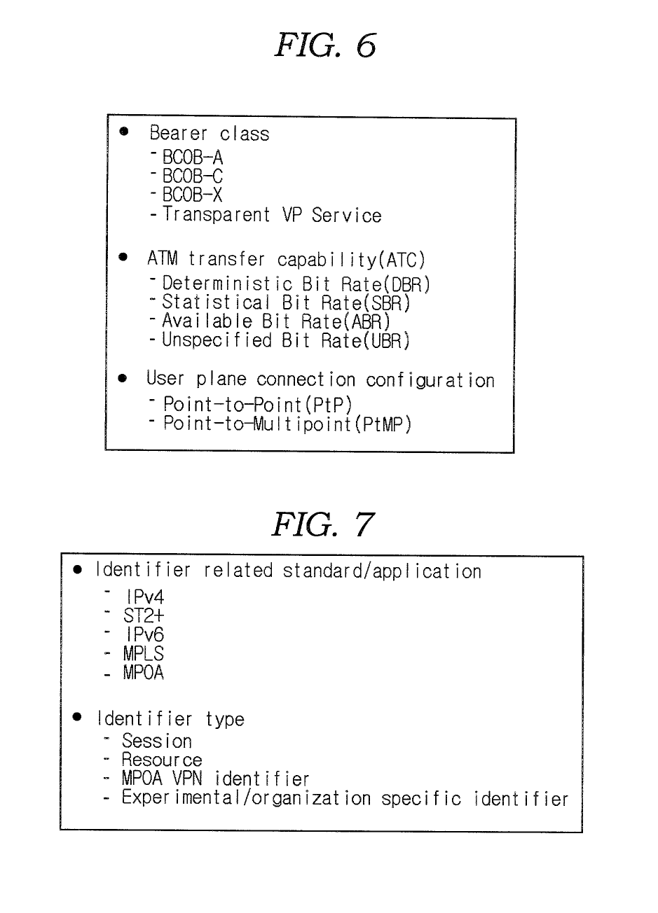

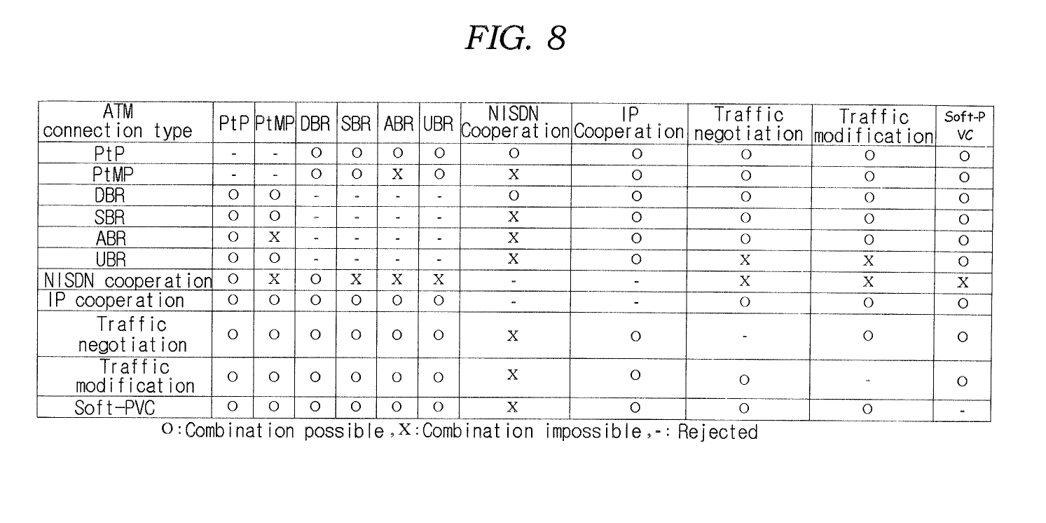

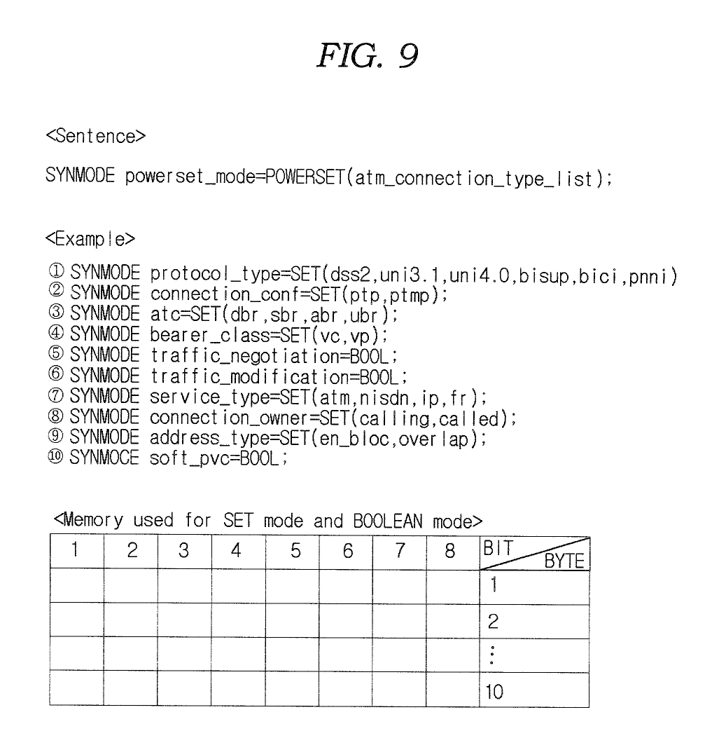

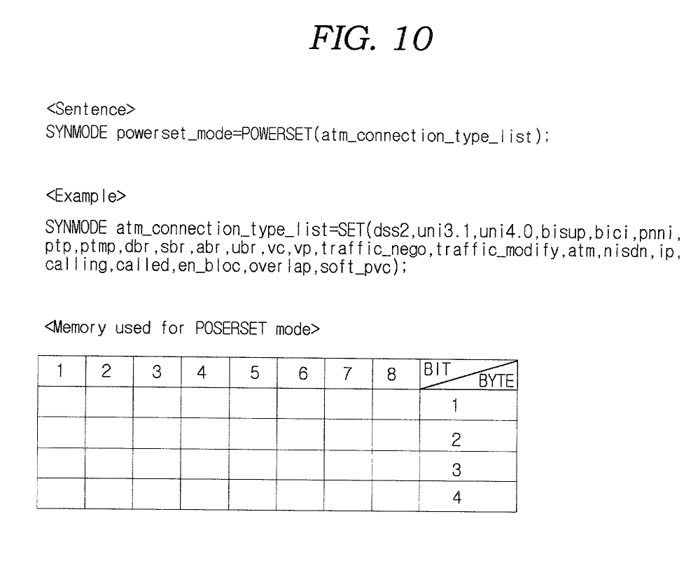

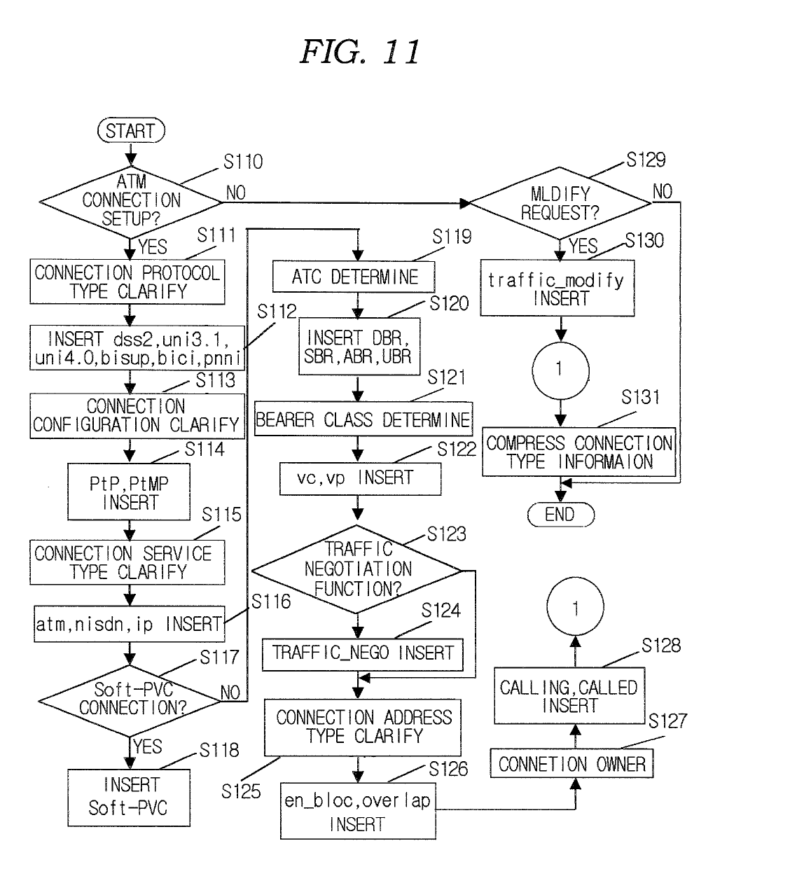

FIG. 4A and 4B illustrate a method for clarifying and compressing the ATM connection type information according to the present invention. In the method of the present invention, information elements of the SETUP message are to be analyzed to sequentially add the ATM connection type.

Table 1 illustrates an information element of the SETUP message that starts the setup for the ATM connection. In Table 1, the requisite information elements that are necessary for the ATM connection setup and a part of information elements that are necessary for clarifying the ATM connection type information are illustrated. This SETUP message which is transmitted from a calling side ATM terminal to the ATM switching system and is transmitted from an ATM switching system to a called side ATM terminal in order to start the ATM connection setup., is used in the case of making use of the ITU-T DSS2 protocol and the UN3.1 and UNI4.0 protocol of the ATM Forum. In the case of the P-NNI signaling protocol of the ATM Forum, the SETUP message is used between two systems. In the case of the ITU-T B-ISUP protocol or the ATM Forum B-ICI protocol, the IAM message is used for the same purpose and procedure instead of the SETUP message.

| Information element | Type | Note |
|---|---|---|
| Protocol discriminator | Mandatory | |
| Call reference | Mandatory | |
| Message type | Mandatory | |
| Message length | Mandatory | |
| ABR set up parameter | Optional | Necessary information element |
| | | in requesting ABR traffic |
| ATM traffic descriptor | Mandatory | |
| Broadband bearer capability | Mandatory | |
| Broadband sending | Mandatory | Necessary information element |
| complete | | in En bloc address signaling |
| Called party number | Mandatory | |
| Minimum acceptable ATM | Optional | Necessary information element |
| traffic descriptor | | in ATM traffic negotiation |
| Narrowband bearer | Optional | Necessary information element |
| capability | | in NISDN cooperation |
| QoS parameter | Mandatory | |
| Soft PVC called endpoint | Optional | Necessary information element |
| | | in requesting soft PVC |
| | | connection |
| Soft PVC calling endpoint | Optional | |
| Generic identifier transport | Optional | Necessary information element |
| | | in internet cooperation |

First of all, the Protocol Discriminator information element in SETUP message and the prescribed interface definition is used to clarify protocol information such as dss2, uni3.1, uni4.0, bisup, bici, and pnni. Here, a Broadband Bearer Capability information element is used to represent vc, vp, dbr, sbr, abr, ubr, ptp, and ptmp connection types. A Broadband Sending Complete information element is used to represent en bloc addressing type and overlap addressing type. A, Minimum Acceptable ATM Traffic Descriptor information element is used to represent traffic_nego (traffic negotiation) connection type. A Narrow-band Bearer Capability information element is used to represent an NISDN connection type information. A soft PVC called endpoint information element is used to represent the Soft PVC connection type information. And the Generic Identifier Transport information element is used to represent an Internet connection type information.

Table 2 illustrates an information element of MODIFY REQUEST message, which is requesting traffic modification after the setup of the ATM connection. The MODIFY REQUEST message is used to represent traffic_modify (traffic modification) connection type. The MODIFY REQUEST message is a message that is used to modify the ATM traffic of an already-setup ATM connection, in the UNI and Private NNI interfaces. In the case of ITU-T B-ISUP signaling protocol or the ATM Forum B-ICI signaling protocol, the MOD (MODIFY REQUEST) message is used for the same purpose and procedure instead of the MODIFY REQUEST message.

TABLE 2

| Information element | Type | Note |
|---|---|---|
| Protocol discriminator | M | |
| Call reference | M | |
| Message type | M | |
| Message length | M | |
| ATM traffic descriptor | M | ATM traffic information |
| | | to be modified |

And also, the MODIFY ACK message is corresponding to the MOA message. In the Public NNI interface, a MOC (MODIFY CONFIRM) message is used.

Table 3 illustrates a configuration of a Broadband Bearer Capability information element that is one of the information elements in SETUP message.

TABLE 3

Bearer class
BCOB-A
BCOB-C
BCOB-X
Transparent VP Service
ATM transfer capability (ATC)
Deterministic Bit Rate (DBR)
Statistical Bit Rate (SBR)
Available Bit Rate (ABR)
Unspecified Bit Rate (UBR)
User plane connection configuration
Point-to-Point (PtP)
Point-to-Multipoint (PtMP)

In Table 3, Broadband Bearer Capability information element consists of Bearer class, the ATC, and User plane connection configuration information. And the Bearer class information denotes VC if its value is BCOB-A, C, X. And the Bearer class information denotes an ATM connection of VP level in the case of Transparent VP service.

The ATM Transfer Capability represents DBR, ABR, and UBR. DBR denotes that a transfer of a deterministic bit rate is requested. ABR makes use of the remaining band available bit rate after occupied by SBR, DBR and SBR of the statistical multiple bit rate. UBR transmits information in accordance with network states without specifying the quantity of band to be used. User plane connection configuration represents whether the requesting connection is a point-to-point (ptp) or a point-to-multipoint (ptmp).

Table 4 illustrates a configuration of a Generic Identifier Transport information element that is one of the information elements in SETUP message. The Generic Identifier Transport information element is included in the SETUP message at the time that the internet service cooperation is requested, The Generic Identifier Transport information element consists of Identifier related standard/application, Identifier type, and the like. The Internet signaling protocols which can be supported to the Generic Identifier Transport information element are IPv4, IPv6, ST2+, MPLS, and MPOA.

TABLE 4

Identifier related standard/application
IPv4
ST2+
IPv6
MPLS
MPOA
Identifier type
Session
Resource
MPOA VPN identifier
Experimental/organization specific identifier

Table 5 illustrates the ATM connection types and the possible combination that are results of analyzing the ATM SETUP message which is requesting the ATM connection setup and MODIFY REQUEST message. The ATM connection type of Table 5 can be applied to control connection acceptance of the ATM connection requesting connection setup. If the SETUP message unmatched to the combination of the ATM connection types is received, the associated connection setup request is rejected and then a RELEASE COMPLETE message is transmitted.

Table 6 illustrates an example in which the SETUP message and the MODIFY REQUEST message are analyzed and connection type information that can be clarified is represented as 10 variables with a SET mode and a BOOLEAN mode of CHILL language. The SET mode and the BOOLEAN mode occupy 1 byte of memory. In the case that the ATM connection types are classified into 10 types, only one connection information occupies 10 byte memory and 10 variables are used for each of the ATM connections. In this case, memory of 10 byte multiplied by the number of the ATM connection which system can simultaneously setup can be occupied for the ATM connection.

Table 7 illustrates connection type information according to the present invention that analyzes a SETUP message and a MODIFY REQUEST message to perform clarification by using a POWERSET mode of CHILL language that consists of one variable and 24 set elements.

TABLE 5

| ATM | | | | | | | NISDN | IP | Traffic | Traffic | Soft- |
|---|---|---|---|---|---|---|---|---|---|---|---|
| connection type | PtP | PtMP | DBR | SBR | ABR | UBR | Cooperation | Cooperation | negotiation | modification | PVC |
| PtP | — | — | ∘ | ∘ | ∘ | ∘ | ∘ | ∘ | ∘ | ∘ | ∘ |
| PtMP | — | — | ∘ | ∘ | X | ∘ | X | ∘ | ∘ | ∘ | ∘ |
| DBR | ∘ | ∘ | — | — | — | — | ∘ | ∘ | ∘ | ∘ | ∘ |
| SBR | ∘ | ∘ | — | — | — | — | X | ∘ | ∘ | ∘ | ∘ |
| ABR | ∘ | X | — | — | — | — | X | ∘ | ∘ | ∘ | ∘ |
| UBR | ∘ | ∘ | — | — | — | — | X | ∘ | X | X | ∘ |
| NISDN cooperation | ∘ | X | ∘ | X | X | X | — | — | X | X | X |
| IP cooperation | ∘ | ∘ | ∘ | ∘ | ∘ | ∘ | — | — | ∘ | ∘ | ∘ |
| Traffic | ∘ | ∘ | ∘ | ∘ | ∘ | ∘ | X | ∘ | — | ∘ | ∘ |
| negotiation | | | | | | | | | | | |
| Traffic | ∘ | ∘ | ∘ | ∘ | ∘ | ∘ | X | ∘ | ∘ | — | ∘ |
| modification | | | | | | | | | | | |
| Soft-PVC | ∘ | ∘ | ∘ | ∘ | ∘ | ∘ | X | ∘ | ∘ | ∘ | — |

∘: Combination possible,
X: Combination immposible,
—: Rejected

TABLE 6
<Sentence>
SYNMODE powerset_mode=POWERSET(atm_connection_type_list);
<Example>

| | |
|---|---|
| \mathring{1} SYNMODE | protocol_type=SET |
| | (dss2,uni3.1,uni4.0,bisup,bici,pnni) |
| \mathring{2} SYNMODE | connection_conf=SET(ptp,ptmp); |
| \mathring{3} SYNMODE | atc=SET(dbr,sbr,abr,ubr) |
| \mathring{4} SYNMODE | bearer_class=SET(vc,vp); |
| \mathring{5} SYNMODE | traffic_negotiation=BOOL; |
| \mathring{6} SYNMODE | traffic_modification=BOOL; |
| \mathring{7} SYNMODE | service_type=SET(atm,nisdn,ip,fr); |
| \mathring{8} SYNMODE | connection_owner=SET(calling,called); |
| \mathring{9} SYNMODE | address_type=SET(en_bloc,overlap); |
| \mathring{10} SYNMODE | soft_pvc=BOOL; |

<Memory used for SET mode and BOOLEAN mode>

| BIT | | | | | | | | |
|---|---|---|---|---|---|---|---|---|
| 1 | 2 | 3 | 4 | 5 | 6 | 7 | 8 | BYTE |
| | | | | | | | | 1 |
| | | | | | | | | 2 |
| | | | | | | | | : |
| | | | | | | | | 10 |

TABLE 7
<Sentence>
SYNMODE powerset_mode=POWERSET(atm_connection_type_list);
<Example>
SYNMODE atm_connection_type_list=SET
(dss2,uni3.1,uni4.0,bisup,bici,pnni,ptp,ptmp,dbr,sbr,abr,ubr,vc,vp,
traffic_nego,traffic_modify,atm,nisdn,ip,
calling,called,en_bloc,over lap,soft_pvc);
<Memory used for POSERSET mode>

| BIT | | | | | | | | |
|---|---|---|---|---|---|---|---|---|
| 1 | 2 | 3 | 4 | 5 | 6 | 7 | 8 | BYTE |
| | | | | | | | | 1 |
| | | | | | | | | 2 |
| | | | | | | | | 3 |
| | | | | | | | | 4 |

The POWERSET mode occupies 4 byte of memory. An advantage of the POWERSET mode is that the configuration method is simpler, and the number of variables and the occupied memory quantity are smaller than that of Table 6 in which a SET mode is used.

Difference between the SET mode and the POWERSET mode are described as follows.

Firstly, the expression of the SET mode is;

<expression >

set_mode::=[READ] SET (name_list);

In Set mode, a set is defined for a predetermined number of non-numerical quantities or discrete values. The values of set elements of the set are represented as names defined in a name_list.

<example >

DCL season SET (SPRING, SUMMER, FALL, WINTER);

DCL weekday SET (SUN, MON, TUE, WED, THU, FRI, SAT);

season :=SPRING;

weekday :=SAT;

Only one element of the defined set elements is allocated to the variable that is asserted by the SET mode in such an example as the above-mentioned example.

In other words, the value of each of elements in the Set mode is not represented as name type in computer. In the Set mode, integer values of 0, 1, 2, . . . , and n are internally represented as in sequence of names as described. The internal representation defines the sequence of the values.

In the above-described example, weekday has 7 elements, and the internal representations are allocated from 0 in array sequence as described. Therefore, SUN, MON, THU, WED, FRI, and SAT are represented with 0, 1, 2, 3, 5, and 6, respectively. That is, the elements in the weekday is represented with (0, 1, 2, 3, 4, 5, 6).

Meanwhile, the expression of the Powerset mode is;

<expression >

powerset_mode ::=[READ] POWER:SET member_mode

member mode ::=set_mode

The powerset mode defines a set of values of member_mode. Here, member_mode have to be a set_mode.

<example >

NEWMODE aspects=SET (fast, remote, duplicated),

NEWMODE status=POWERSET aspects;

In the above-described example, a member mode of status is to be a ‘aspects’. And the value of status is to be values of tuple, as follows.

1) []

2) [fast]

3) [remote]

4) [duplicated]

5) [fast, remote]

6) [fast, duplicated]

7) [remote, duplicated]

8) [fast, remote, duplicated]

The value of each of elements in the Powerset mode is not represented as name type in computer. In the Powerset mode, integer values of 1, 2, 4, 8, . . . , and 2n−1 are internally represented as in sequence of names as described. The internal representation defines the sequence of the values. Here, n is the number of the elements.

In the above-described example, status has 3 elements, and the internal representations are allocated from 1 in array sequence as described. Therefore, ‘fast’, ‘remote’, and ‘duplicated’ are represented with 1, 2, and 4, respectively. That is, the elements in the status are represented with (1, 2, 4).

As combinations of the elements, tuple [fast, remote] is to be 3 (1+2), [fast, duplicated] is to be 5 (1+4), [remote, duplicated] is to be 6 (2+4), and [fast, duplicated] is to be 7 (1+2+4).

And then, The POWERSET mode is allocated with combination of elements defined by the SET mode.

As described in details, in order to clarify and compress a connection type information, a received message is to be identified whether it is the SETUP message or not (S110). If the received message is the SETUP message, clarification and compression of connection type information for connection setup are performed through steps S111 to S128 and step S131.

If the received message is the MODIFY REQUEST message, steps S130 and S131 are performed to add traffic modification information to connection type information, which are to be compressed.

If the received message is the SETUP message, protocol types (dss2, uni3.1, uni4.0, bisup, bici, and pnni) are clarified using Protocol Discriminator and interface information, and then inserted into connection type information (S111 and S112).

After that, connection configurations (ptp and ptmp) are clarified from Broadband Bearer Capability information element and then inserted into connection type information (S113 and S114).

And then, it is performed to determine whether Narrow-band bearer capability and Generic identifier transport information element exist. And the Narrowband bearer capability and Generic identifier transport information element are analyzed so that service types (ATM, nisdn, and ip) to be served are determined. And then, service types (ATM, nisdn, and ip) is to be inserted into connection type information (S115 and S116).

It is performed to determine whether Soft PVC called endpoint information element in the received SETUP message, thereby checking that Soft-PVC connection is to be requested (S117). If the Soft PVC called endpoint information element exists. A soft_pvc is subjected to be inserted into connection type information.

Consequently, ATC (DBR, SBR, ABR, and UBR) is determined from Broadband Bearer Capability information element to be inserted into connection type information (S119 and S120). Similarly, Bearer class (vc and vp) is determined from Broadband Bearer Capability information element to be inserted into connection type information (S121 and S122).

It is performed to determine whether Minimum acceptable ATM traffic descriptor information element, thereby checking that traffic negotiation function (traffic_nego) can be served (S123). If Minimum acceptable ATM traffic descriptor information element exists. A traffic_nego is subjected to be inserted into connection type information (S124).

In addition, The address type (en bloc and overlap) to be serves are determined from Broadband Sending Complete information element to be inserted into connection type information (S125, S126).

It is determined whether the associated ATM call control module receives or transmits the SETUP (or IAM) message. In accordance with the result of the determination, connection owners (calling and called owners) are subjected to be clarified to be inserted into connection type information (S127, 128).

When all connection type information are clarified, all the clarified connection type information are subjected to be compressed into one variable by making use of the POWERSET mode (S131).

Meanwhile, when the MODIFY REQUEST message is received (S129), a traffic modification function (traffic_modify) is subjected to be added to the connection type information (S130). And then, the connection type information which is added with the traffic modification function (traffic_modify) are subjected to be compressed into one variable by making use of the POWERSET mode through step S131.

As the above described, the present invention is to analyze the SETUP message and the MODIFY REQUEST message used in the ATM signaling protocol for the setup of the ATM connection and to clarify the ATM connection type and then by making use of the POWERSET mode to compress 10 ATM connection type information into one ATM connection type information, so that usage of memory and information quantity of the ATM connection type information used in the ATM call control module and the operational management module can be reduced and management efficiency for the ATM connection type in the ATM network can be enhanced. And also, signaling protocol and connection information to be used for the ATM connection setup can be easily identified.

The foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

What is claimed is:

1. A method for clarifying and compressing an ATM connection type information for an ATM connection setup in accordance with an ATM signaling protocol in an ATM call control module being located between an ATM terminal and an ATM switching system, said ATM call control module performing an ATM connection setup function, said method comprising:
a first step of receiving an ATM SETUP message, said ATM SETUP message requesting said ATM connection setup form said ATM calling terminal;
a second step of analyzing information elements included in said received SETUP message to determine ATM connection types to be setup, thereby clarifying connection type information; and
a third step of compressing said clarified connection type information into one connection type information,
wherein said ATM call control module includes a predetermined combinations of said ATM connections which can be updated.

2. The method according to claim 1 further comprising:
a fourth step of rejecting connection setup request to transmit a reject message to said ATM calling terminal and completing a ATM connection setup procedure, when said determined ATM connection type is not matched to said predetermined combinations of said ATM connections, and
wherein said fourth step is disposed after said second step.

3. The method according to claim 1, wherein said connection type information includes:
ATM connection protocol information (dss2, uni3.1, uni4.0, bisup, bici, and pnni) that are clarified through Protocol Discriminator and interface information among said information elements;
ATM connection configuration information (vc, vp, dbr, sbr, abr, ubr, ptp, and ptmp) that is clarified through Broadband Bearer Capability among said information elements;
ATM signal transmission information (en bloc and overlap) which are clarified though Broadband Sending Complete among said information elements;
ATM traffic negotiation information (traffic_nego) which are clarified though Minimum Acceptable ATM Traffic Descriptor among said information elements;
ATM service type information (nisdn) which are clarified though Narrowband Bearer Capability among said information elements;
ATM virtual connection information (soft_pvc) which are clarified though Soft PVC called Endpoint among said information elements; and
ATM service type information (ip) which are clarified though Generic Identifier Transport among said information elements.

4. The method according to claim 3, wherein said third step includes a step of recording all of said clarified ATM connection type information to one variable (ATM_connection_type_list) of POWERSET mode which is defined with CHIL language, as follows:
SYNMODE powerset_mode=POWERSET(ATM_connection_type_list).

5. The method according to claim 4, further comprising: a step of adding connection type information (traffic_modify) which represents traffic modification function to said one variable, when MODIFY REQUEST message which intends to modify connection type is received after said ATM connection is setup.

6. The method according to claim 5, wherein a IAM message instead of said SETUP message is used when said ATM signaling protocol is ITU-T B-ISUP or ATM Forum B-ICI.

7. A media readable with a computer, in which a program is recorded, said program performing procedures for clarifying and compressing an ATM connection type information for an ATM connection setup in accordance with an ATM signaling protocol in an ATM call control module being located between an ATM terminal and an ATM switching system, said ATM call control module performing an ATM connection setup function, wherein said procedures comprising:
a first procedure of receiving an ATM SETUP message, said ATM SETUP message requesting said ATM connection setup form said ATM calling terminal;
a second procedure of analyzing information elements included in said received SETUP message to determine said ATM signaling protocol and an ATM connection type to be setup, thereby clarifying said connection type information; and
a third procedure of compressing said clarified connection type information into one connection type information.
